(19) United States
(12) Patent Application Publication
(10) Pub. No.: US 2008/0010207 A1
(43) Pub. Date: Jan. 10, 2008

(54) Information delivery system, node device, method to issue unrestricted data, and the like

(75) Inventors: Yasushi Yanagihara, Nagoya-shi (JP); Yuji Kiyohara, Nagoya-shi (JP)

Correspondence Address: OLIFF & BERRIDGE, PLC, P.O. BOX 320850, ALEXANDRIA, VA, 22320-4850, US

(73) Assignee: BROTHER KOGYO KABUSHIKI KAISHA, Nagoya-shi (JP)

(21) Appl. No.: 11/892,938

(22) Filed: Aug. 28, 2007

Related U.S. Application Data
(63) Continuation-in-part of application No. PCT/JP2006/304356, filed on Mar. 7, 2006.

(30) Foreign Application Priority Data
Mar. 11, 2005 (JP) 2005-068390

(51) Int. Cl. H04L 9/00

(52) U.S. Cl. 705/51

(57) ABSTRACT

The present invention is to provide an information delivery system including a plurality of node devices enabled to mutually communicate via a network where the authentication processing regarding issuance of request data to release restriction for playback of each of delivery information pieces is performed by a plurality of node devices in a distributed manner, it is possible to prevent request concentration to a specific device such as a server, and therefore the load of authentication processing is drastically reduced compared with conventional client-server architecture.

### CROSS REFERENCE TO RELATED APPLICATION

The present claims priority from Japanese Patent Application No. 2005-068390 which was filed on Mar. 11, 2005, the disclosure of which is herein incorporated by reference in its entirety.

### BACKGROUND OF THE INVENTION

1. Field of the Invention

The present invention relates to a peer to peer (P2P) information delivery system and the like including a plurality of node devices which can communicate with each other via a network and, especially, relates to a technical field of a content delivery system and the like in which a plurality of digital content to which playback-restriction has been applied are distributed and saved in a plurality of node devices.

2. Discussion of Related Art

Conventionally, in a client server model content delivery system, from a viewpoint of copyright protection, digital rights management (DRM) by which a user must acquire a license to play back content data (digital content) has been well known.

For example, in Patent Document 1, a content delivery system in which a client requests license acquisition to a license server and the license server performs license authentication and issues a content key (decryption key) to playback encrypted content data has been disclosed. Moreover, in Patent Document 2, a technique used when a license server issues a license corresponding to content data has been disclosed.

Patent Document 1: Japanese Published Unexamined Patent Application No. 2004-227283

Patent Document 1: Japanese Published Unexamined Patent Application No. 2004-046856

### SUMMARY OF THE INVENTION

Recently, unlike the above-mentioned client server model, a peer to peer (P2P) model in which a client (node device) can freely participate in or withdraw from a network (for example, by turning on/off power source) has been attracting attention. Napster or Gnutella which are well-known for music delivery service are examples of such a system.

In such a P2P model, various content data are distributed in many node devices to be saved and the content is delivered on demand. Whenever each processing is generated, a license server performs license authentication and content key issuance processing to ensure safety or the like regarding copyright protection. On the other hand, there arises the concentration problem regarding request for copyright management on the license server.

The present invention has been made in consideration of the above problem and is aimed at providing an information delivery system, a node device, a method for issuing playback-restriction releasing data (decryption key) and the like which enables to reduce concentration of request for copyright management on a specific device such as a server.

According to the present invention, since the authentication processing regarding issuance of playback-restriction releasing data is performed by a plurality of node devices in a distributed manner, it is possible to reduce request concentration of request for copyright management on a specific device such as a server.

### BRIEF DESCRIPTION OF THE DRAWINGS

FIG. 1 shows an example of connection status of each node device in a content delivery system according to the present embodiment.

FIG. 2 shows a DHT routing in case where a user node acquires a content protection key in a node ID space of a DHT.

FIG. 3 shows an example of schematic structure of a node device 1.

FIG. 4 shows an example of schematic structure of an IC card.

FIG. 5 shows an example of schematic structure of a license server 2.

FIG. 6 shows an example of schematic structure of tamper proof secure board.

FIG. 7 shows an overall processing flow in a content delivery system S.

FIG. 8 is a flow chart showing content data encryption and storage processing by a control part 31 of the license server 2.

FIG. 9 shows an example of protection key management information piece registered in a content protection key management table.

FIG. 10 shows an example of how to update a content protection key.

FIG. 11 is a flow chart showing THE RIGHT CERTIFICATE FOR DELEGATE AUTHENTICATION issuance processing by the control part 31 of the license server 2.

FIG. 12 is a flow chart showing license certificate purchase processing by a control part 11 of a user node 1a.

FIG. 13 is a flow chart showing license certificate issuance processing by the control part 31 of the license server 2.

FIG. 14 is a schematic diagram showing an example of content described in a license certificate.

FIG. 15 is a flow chart showing DRM processing (processing performed when a content protection key is requested) by the control part 11 of the user node 1a.

FIG. 16 is a flow chart showing license authentication processing by a control part 11 of an authentication node 1x.

FIG. 17 is a flow chart showing protection key issuance processing by a control part 11 of a root node 1y.

FIG. 18 is a flow chart showing DRM processing (processing performed when a content protection key is requested) by the control part 11 of the user node 1a.

FIG. 19 is a flow chart showing blacklist registration processing by the control part 11 of the root node 1y.

FIG. 20 is a flow chart showing protection key issuance destination check processing by the control part 31 of the license server 2.

FIG. 21 is a flow chart showing DRM processing in a case where license certificate is updated by the control part 11 of the user node 1a when.

FIG. 22 is a flow chart showing license authentication and update processing in the control part 11 of the authentication node 1x.

### DETAILED DESCRIPTION OF THE PREFERRED EMBODIMENTS

The present invention is not confined to the configuration listed in the foregoing embodiments, but it is easily understood that the person skilled in the art can modify such configurations into various other modes, within the scope of the present invention described in the claims. Hereinafter, each designation of numerical reference in the drawings is typically as follows:
1: node;
2: license server;
8: network;
9: overlay network;
11: control part;
12: storage part;
13: buffer memory;
14: accelerator for decryption;
15: decoder part;
16: image processing part;
17: display part;
18: audio processing part;
19: speaker;
20: IC card slot;
21: communication part;
22: input part;
23: bus;
25: IC card;
31: control part;
33: accelerator for encryption;
34: encoder part;
35: board slot;
36: communication part;
37: input part;
38: bus;
40: tamper-proof secure board; and
S: content delivery system

### Embodiments

Hereafter, a first embodiment of the present invention will be explained based on figures. Note that embodiment explained below is a case where the present invention is applied to a content delivery system.

[1. Configuration and the Like of Content Delivery System]

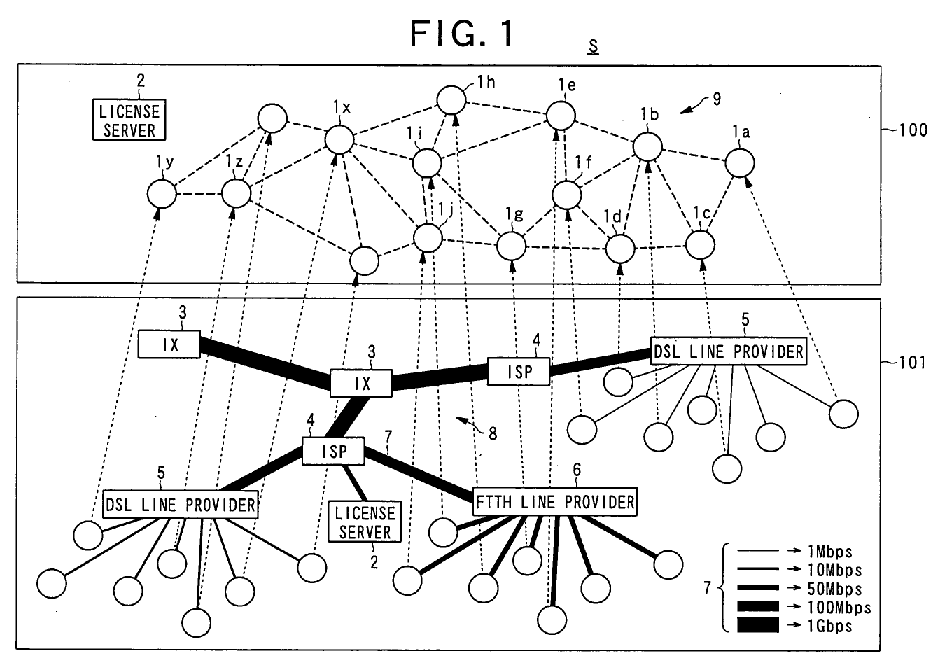

First, with reference to FIG. 1, general configuration and the like of a content delivery system will be explained.

FIG. 1 shows an example of connection status of each of node devices in a content delivery system according to the present embodiment.

As shown in lower rectangular frame 101 in FIG. 1, a network 8 (network in real world) of the Internet or the like is configured by an internet exchange (IX) 3, internet service provider (ISP) 4, digital subscriber line provider (or device thereof) 5, fiber to home line provider ('s device) 6, a router (not shown), and communication line (for example, such as a telephone line or an optical cable) 7 and the like.

A content delivery system S is configured by a plurality of node devices 1a, 1b, 1c . . . 1x, 1y, 1z . . . which are connected with each other via such network 8 as communication means and is a peer to peer network system. Moreover, to each of the node devices 1a, 1b, 1c . . . 1x, 1y, 1z . . . , unique production number and internet protocol (IP) address have been assigned respectively. Note that none of production number and IP address overlaps in a plurality of node devices 1. In the explanation below, the node devices 1a, 1b, 1c . . . 1x, 1y, 1z . . . will be collectively referred to as a “node 1”.

Moreover, the content delivery system S includes a license server 2 which is connected to the network 8.

As an example of such a system, an overlay network 9 shown in the upper rectangular frame 100 of FIG. 1 is configured under DHT algorithm. In other words, the overlay network 9 means virtual network built on physical network 8.

In the present embodiment, each description is introduced on the assumption that system is based on an overlay network 9. A node device 1 provided on this overlay network 9 is called a node device 1 participating in the content delivery system S (in other words, participating in the overlay network 9). Note that participation into the content delivery system S is performed when a non-participating node 1 sends participation request to any arbitrary node 1 which has already participated in.

Moreover, each of the node 1 participating in the overlay network 9 has a node ID as identification information and the node ID is, for example, a value obtained by hashing an IP address or production number by a common hash function (for example, SHA-1 or the like) (for example, bit length thereof is 160 bit) and is distributed and located in one ID space without deviation. Each of the (hashed) node IDs obtained by a common hash function in such a manner has a very low possibility of having same values when the IP address or the production number differs with each other. Note that regarding hash function, since it is heretofore known, detailed explanation thereof is omitted. Note that in the present embodiment, node ID is obtained by hashing an IP address (global IP address) by a common hash function.

In addition, each of the participating node 1 has a DHT respectively. In the DHT, route information to other nodes 1, that is, a plurality of node IDs and IP addresses of other nodes 1 is registered. Such a DHT is given when a non-participating node participates in the overlay network 9. Furthermore, in the content delivery systems, since node 1 repeats participation and withdraw, it is periodically confirmed whether update of DHT is necessary or not (for example, with an interval of several dozen minutes to several hours) and, as the same time, the update information is transmitted to other nodes 1 according to routes registered in the DHT. Thus, it is possible to keep DHT in the latest condition. Note that regarding DHT algorithm, since it is heretofore known, detailed explanation thereof is omitted.

Moreover, any plurality of nodes 1 participating in the overlay network 9 retain (possess) a public key (a public key in so-called public key cryptosystem) of the license server 2. The nodes 1 can decrypt the encrypted electronic data (for example, the encrypted hashed value of license certificate or THE RIGHT CERTIFICATE FOR DELEGATE AUTHENTICATION which will be described later) by use of the public key of the license server 2. Meanwhile, since only the license server 2 retains (possesses) the secret key in the license server 2, encrypting electronic data by use of the secret key means that the license server 2 signs on the electronic data (electronic signature). Seen from another standpoint, to decrypt the above electronic data by use of a public key of the license server 2 means verifying authorship of the electronic data.

Furthermore, in the overlay network 9, various content data (for example, such as a movie or music) are distributed in a plurality of participating nodes 1 to be saved (stored). For example, in a node 1a, content data of a movie titled XXX is saved while in a node 1b, content data of a movie title YYY is saves. In such a manner, different content data are distributed and saved in the plurality of participating nodes 1. Still furthermore, some content data is not always saved in one node 1 and the one same content data may be saved in a plurality of nodes 1. For the content data, a content name (title) or the like is assigned respectively.

In addition, playback-restriction is applied to all the content data thus distributed and saved for protection.

Here, playback-restriction means a condition where the content data cannot be played back directly as it is and the restriction to prevent a user from viewing the content is applied. In the present embodiment, playback-restriction is performed by encrypting the content data using an encryption key. The playback-restriction on the content data, that is, encryption of the data, is released by a decryption key as playback-restriction releasing data (hereinafter referred to as “content protection key”) and thus, a viewer can view the content.

In the present embodiment, such encryption of content data is performed by the license server 2 and the encrypted content data is delivered to an appropriate node 1 by the license server 2 to be saved.

Note that in the following explanation, content data thus encrypted will be referred to as already-protected content data and a node 1 in which the already-protected content data is saved will be referred to as a replica node (content holder node).

Moreover, location information which indicates location of the already-protected content data (for example, IP address of a replica node in which already-protected content data is saved) is also distributed among a plurality of nodes 1 participating in the overlay network 9 to be saved. For example, a content name of certain content data (or first a few bytes of the content data) is hashed by a hash function commonly used for obtaining the node ID, and location information of already-protected content data is stored into the node 1 (hereinafter referred to as “root node”) having a node ID which is the closest (for example, matches the most in the upper digits) to the hashed value (the hashed value becomes the content ID). In other words, even when many copies of one same content data (having same content ID) are saved in a plurality of replica nodes, location information (such as IP addresses of the plurality of replica nodes) can be managed by one root node (note that in the present embodiment, location information of content data corresponding to one content ID is saved in one root node (that is, the root node and the location information have 1:1 relation), but not limited thereto).

Then, a node on which a user wants to obtain (download) certain content data (hereinafter referred to as a “user node”) transmits the query (inquiry information) to another node 1 under DHT algorithm. As a consequence, the query is relayed to a further alternative node1 (“relay node”), and as the end of continuous relay processing it is delivered to the root node which saves location information indicating location of the content data. Each of the relay nodes compares the content ID attached to the query thus received and node ID registered in the DHT, specifies a node 1 to which the query is to be transferred next (for example, specifies an IP address of a node 1 corresponding to a node ID of which upper digit numbers match that of the node ID's most), and transfers the query thereto. Thus, the user node acquires (receives) location information from the router node and based on the location information, is connected to a replica node which saves the content data and is enabled to acquire (receive) content data therefrom.

Note that since transfer method of a query from a user node to a root node is heretofore known by, for example, “Pastry” or the like, detailed explanation thereof is omitted here. Furthermore, it may be structured so that the response of a user node query is transmitted when the query reaches the node1 that caches the same location information as that of a root node before the query reaches the root node.

Meanwhile, as described above, content protection key is required to normally play back already-protected content data. In the present embodiment, a node 1 for performing authentication processing regarding issuance permission of the content protection key (hereinafter referred to as “authentication node”) and a node 1 for performing issuance processing of the content protection key (hereinafter referred to as “content protection key issuance node”) exist for each of already-protected content data (in other words, when content data (content ID) differs, an authentication node and a content protection key issuance node also differ accordingly). Hence, authentication processing regarding issuance permission of the content protection key is performed by authentication nodes corresponding to each of the already-protected content data (that is, authentication processing is distributed) and issuance processing of content protection key is performed by content protection key issuance nodes corresponding to each of already-protected content data (for each content ID) (that is, issuance processing is distributed).

Note that in the present embodiment, when content name (or first some bytes of content data) of the content data (already-protected content data)+suffix (for example, specific string unitary in the content delivery system S) is hashed by a hash function commonly used to obtain the node ID, a node 1 having a node ID closest (for example, one which matches in the upper digits with the hashed value the most) to the hashed value (the hashed value becomes an authentication ID) becomes an authentication node corresponding to the content data. Moreover, in the following explanation, a case where a root node functions as content protection key issuance node is taken as an example.

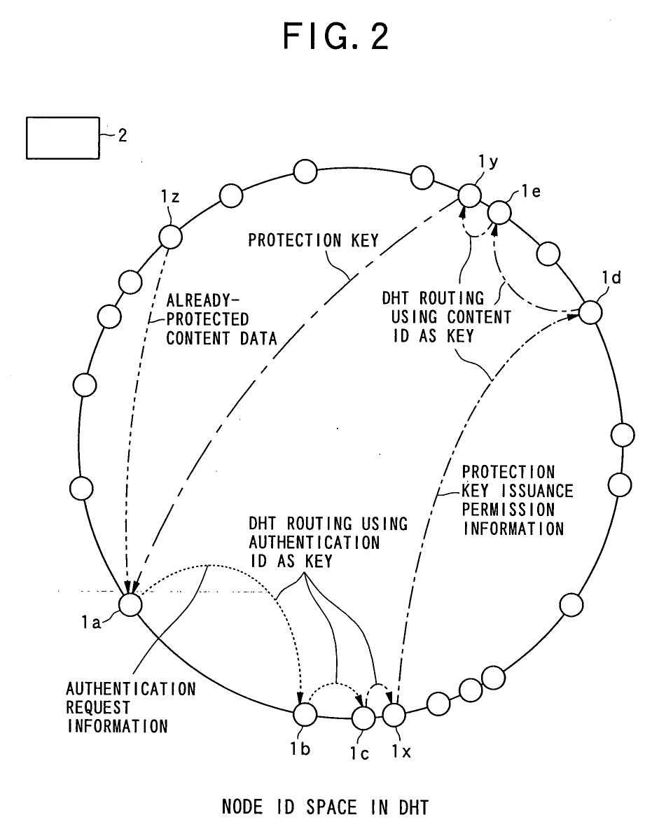

Here, with reference to FIG. 2, a basic flow of a case where a user node acquires a content protection key will be explained.

FIG. 2 is an example of DHT routing in case where a user node acquires a content protection key in a node ID space of a DHT.

In the example of FIG. 2, a user node 1a purchases a license certificate (which has been signed by a license server 2) as an acquisition right of a content protection key for already-protected content data from the license server 2 and transmits authentication request information, which indicates authentication request of the license certificate and to which the license certificate, authentication ID, and an IP address of the user node 1a have been attached, to other node 1.

Then, the authentication request information thus transmitted passes through relay nodes 1b and 1c and reaches an authentication node 1x which corresponds to the already-protected content data (that is, a node having node ID closest to a value obtained by hashing content name of the content data+suffix) (authentication ID). Note that in each of the relay nodes, authentication ID attached to the authentication request information and node ID registered in a DHT are compared to specify a node 1 to which the authentication request information is to be transferred next (for example, specify an IP address of a node ID which corresponds to a node ID of which upper digit numbers match that of the authentication ID), and the authentication request information is transferred to a node thus specified.

Receiving the authentication request information, the authentication node 1x performs authentication processing, that is, authentication of validity of the license certificate (verification of validity), regarding issuance permission of a content protection key corresponding to the already-protected content data based on the license certificate attached to the information. Note that though details will be given later, to the authentication node 1x, license authentication right has been given from the license server 2 (in other words, license authentication right has been transferred from the license server 2) and the authentication node 1x has THE RIGHT CERTIFICATE FOR DELEGATE AUTHENTICATION (signed by the license server 2) as an example of authentication right certificate data certifying the authentication right.

Then, the authentication node 1x transmits protection key issuance permission information, which indicates issuance permission of a content protection key corresponding to the already-protected content data and to which THE RIGHT CERTIFICATE FOR DELEGATE AUTHENTICATION, content ID of the already-protected content data, IP address of the user node 1a, and the like have been attached, to another node 1 when it is authenticated that the license certificate is valid in the authentication processing.

The protection key issuance permission information thus transmitted passes through relay nodes 1d and 1e and reaches root node 1y which is a content protection key issuing node corresponding to the already-protected content data (that is, a node having a node ID closest to the content ID of the content data).

The root node 1y which has received the protection key issuance permission information confirms authentication right of the authentication node 1x, that is, authentication of validity of THE RIGHT CERTIFICATE FOR DELEGATE AUTHENTICATION attached to the protection key issuance permission information (examination of validity). When it is authenticated that THE RIGHT CERTIFICATE FOR DELEGATE AUTHENTICATION is valid, protection key is transmitted to the user node 1a. Thus, the user node 1a is connected to a replica node 1z which saves the already-protected content data based on location information thus received, acquire the already-protected content data therefrom, and decodes the already-protected content data by the content protection key thus received to play back the data.

[2. Configuration of Node]

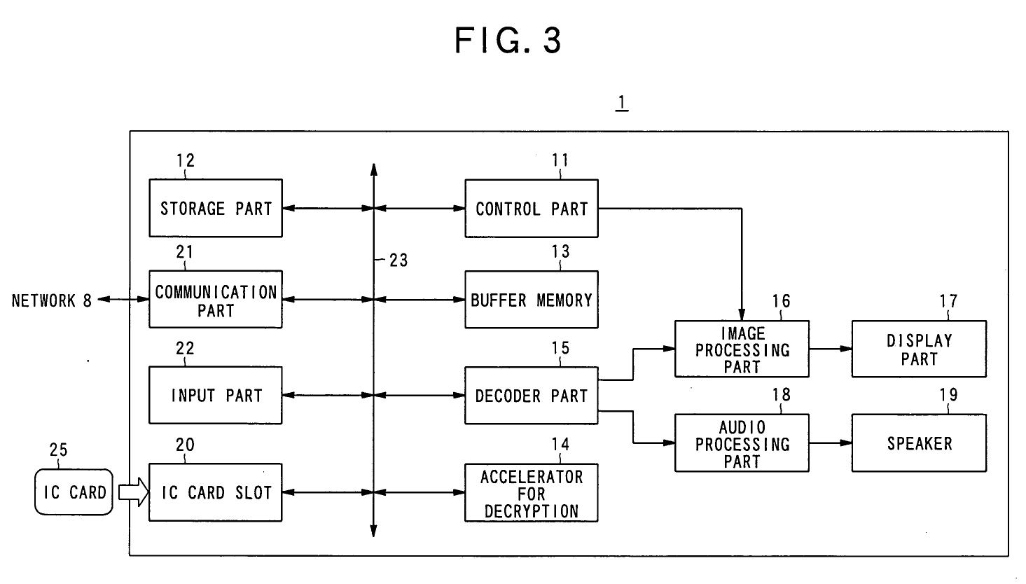

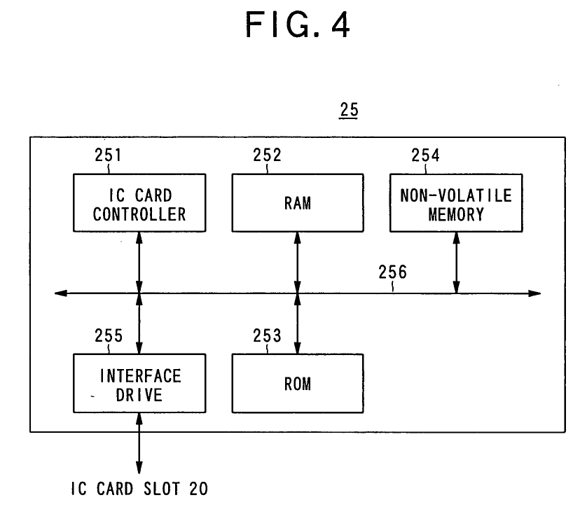

Next, with reference to FIGS. 3 and 4, configuration and function of a node 1 in the content delivery system S will be explained.

FIG. 3 shows an example of schematic structure of a node 1 and FIG. 4 shows an example of schematic structure of an IC card.

Each of nodes 1 is configured by including, as shown in FIG. 3, a control part 11 which is a computer configured by including a CPU having computing function, a RAM for work, and a ROM for saving various data and programs (including an OS and various types of applications), a storage part 12 configured by an HDD or the like for saving and retaining (storing) various data (for example, such as already-protected content data), DHT and the like, a buffer memory 13 for temporarily storing received already-protected content data, a decryption accelerator 14 for decrypting already-protected content data, a decoder part 15 for decoding (stretch data or the like) encoded (compressed or the like) video data (image information) and audio data (voice information) included in the decrypted content data, an image processing part 16 (including a video chip) for performing predetermined graphic processing to the decoded video data or the like to output the data as video signal, display part 17 such as CRT or liquid crystal display for displaying image based on the video signal outputted from the image processing part 16, audio processing part 18 for converting the decoded audio data by digital/analog (D/A) conversion into analog audio signal and thereafter amplifying the converted signal by an amplifier to output, a speaker 19 for outputting the audio signal outputted from the audio processing part 18 as acoustic wave, an IC card slot 20 for inserting an IC card 25, communication part (a network interface) 21 for performing communication control of information between other nodes 1 or a license server 2 via the network 8, and input part 22 which receives instruction from a user and provides instruction signal corresponding to the instruction to the control part 11 (for example, such as a key board, a mouse, or an operation panel) and the control part 11, the storage part 12, the buffer memory 13, the decoder part 14, and the communication part 20 are connected with each other via a bus 22.

In such a configuration, in the control part 11, the CPU reads out and performs a program saved in the storage part 12 or the like to control the whole of the nodes 1 and, at the same time, performs participation request processing to the overlay network 9 according to an instruction from a user via the input part 22 to obtain the above-mentioned DHT. Thus, the node 1 comes to have basic functions such as transmit/receive data (for example, content data) with other nodes 1 and transfer content data to other nodes 1.

For the node 1 to function as the above-mentioned user node 1a, authentication node 1x, or root node 1y, an IC card 25 which is tamper-proof (that is, countermeasures against tampering have been applied to prevent confidential data from being read out by illegal means and being analyzed easily) is required and the IC card 25 is, for example, distributed by an operator of the license server 2 or the like to a user.

The IC card 25 is configured by including, as shown in FIG. 4, an IC card controller 251 including a CPU, a RAM 252, a ROM 253, a non-volatile memory (for example, EEPROM) 254 which is tamper-proof, and an interface drive 255 and each of them are connected with each other via a bus 256. In the ROM 253, programs corresponding to the user node 1a, authentication node 1x, or root node 1y which the nodes 1 come to function as are saved and in the non-volatile memory 254, data corresponding to the user node 1a, authentication node 1x, and root node 1y which the nodes 1 come to function as are saved.

When the node 1 is used as the user node 1a, a license certificate purchase processing program and a digital rights management (DRM) processing program are saved in the ROM 253 in advance and in the non-volatile memory 254, a user ID unique to each user (for example, given to the user when the IC card 25 is distributed in a sequence by the order of user registration number), a public key of the license server 2, an IP address and the like are saved in advance. Moreover, in this case, in the non-volatile memory 254, license certificate, content protection key, THE RIGHT CERTIFICATE FOR DELEGATE AUTHENTICATION and the like are saved.

Meanwhile, when the node 1 is used as the authentication node 1x, a license authentication processing program and the like are saved in the ROM 253 in advance and in the non-volatile memory 254, a public key of the license server 2 and the like are saved in advance. Moreover, in this case, in the non-volatile memory 254, THE RIGHT CERTIFICATE FOR DELEGATE AUTHENTICATION and a public key and a secret key of the authentication node 1x and the like are saved (THE RIGHT CERTIFICATE FOR DELEGATE AUTHENTICATION may be saved in the non-volatile memory 254 in advance).

On the other hand, when the node 1 is used as the root node 1y, a protection key generation/management processing program, a protection key issuance processing program, a blacklist registration processing program, and the like are saved in the ROM 253 in advance, and in the non-volatile memory 254, a public key of the license server 2 and an IP address and the like are saved in advance. Moreover, in this case, a (later-mentioned) content protection key management table, a content protection key, a content protection key issuance destination list, and a blacklist and the like are saved in the non-volatile memory 254.

When the IC card 25 is inserted into the IC card slot 20, control part 11 of the node 1 and the IC card controller 251 of the IC card 25 are enabled to perform data communication via the interface drive 255.

Then the control part 11 of the node 1 reads the license certificate purchase program or the DRM processing program saved in the ROM 253 via the IC card controller 251 to execute the program on the RAM. Thus, the node 1 is caused to function as the user node 1a (the first node device in the present invention).

Meanwhile, when the control part 11 of the node 1 reads a license authentication processing program and the like saved in the ROM 253 to execute the read program on the RAM, the node 1 is caused to function as the authentication node 1x (the second node device of the present invention).

On the other hand, when the control part 11 of the node 1 reads a protection key generation/management processing program, a protection key issuance processing program, a blacklist registration processing program, or the like saved in the ROM 253 to execute the read program on the RAM, the node 1 is caused to function as the root node 1y (the third node device of the present invention).

Note that detailed processing in the user node 1a, the authentication node 1x, and the root node 1y will be described later.

[3. Configuration and the Like of License Server]

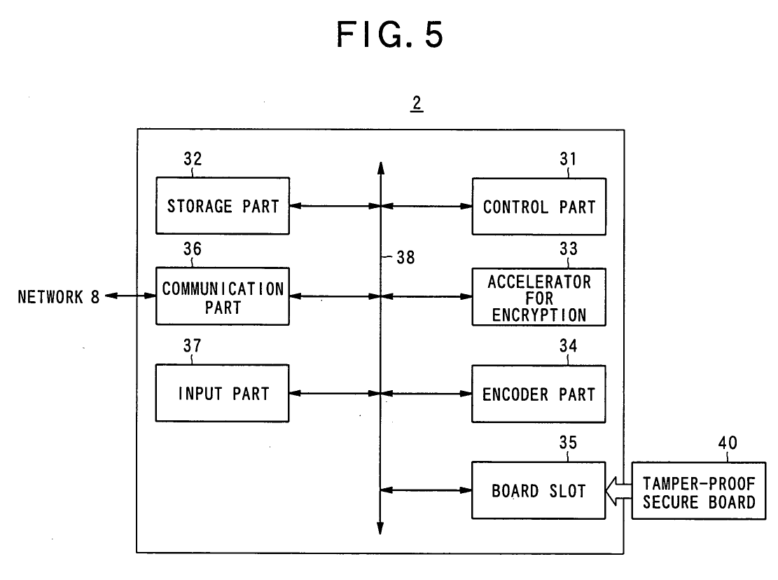

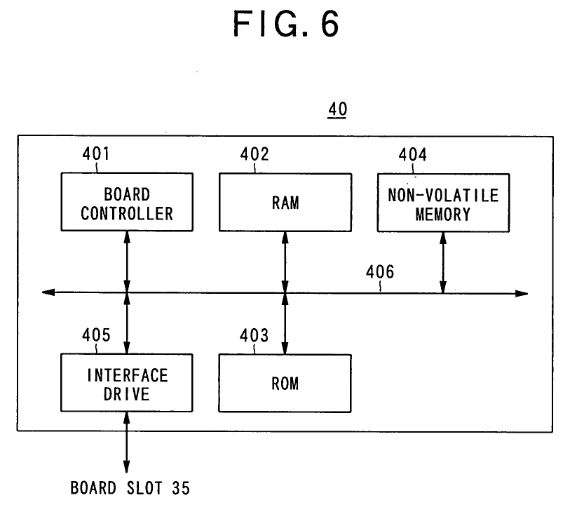

Next, with reference to FIGS. 5 and 6, configuration and function of the license server 2 in the content delivery system S will be explained.

FIG. 5 shows a schematic configuration example of the license server 2 and FIG. 6 shows a schematic configuration example of a tamper-proof secure board.

The license server 2 is configured by including a control part 31 which is configured by including a CPU having computing function, a RAM for work, and a ROM for storing various data and programs (including operating system and various applications), a storage part 32 configured by an HDD or the like for saving and retaining (storing) various data (for example, content data) and the like, an accelerator for encryption 33 for generating already-protected content data by encrypting content data, an encoder 34 for encoding (codec conversion or the like) content data, a board slot 35 for mounting the tempering proof secure board 40, communication part (a network interface) 36 for performing communication control of information between other nodes 1 via the network 8, and input part 37 which receives instruction from an operator and provides instruction signal corresponding to the instruction to the control part 31 (for example, such as a key board, a mouse, or an operation panel) and each of these components are connected with each other via a bus 38.

Moreover, in the storage part 32, already-protected content management database, management database of right certificate for delegate authentication, and license certificate issuance destination management database are configured. In the already-protected content management database, information regarding delivered already-protected content data (for example, content name, expiration date of the content data (for example, a period during which playback or copy of the data is available), number of times that the data can be played back, number of times that the data can be reproduced (copied), or the like), and information regarding a replica node in which the already-protected content data has been saved (for example, IP address of the replica node, authentication ID, etc.) are coordinated and registered. In the management database of right certificate for delegate authentication, issued THE RIGHT CERTIFICATE FOR DELEGATE AUTHENTICATION and information regarding an authentication node to which THE RIGHT CERTIFICATE FOR DELEGATE AUTHENTICATION has been provided (for example, IP address of an authentication node, authentication ID, etc.) are coordinated and registered. In the license certificate issuance destination management database, issued license certificate and information regarding a user node to which the license certificate has been provided (for example, IP address of a user node, user ID, etc.) are coordinated and registered.

The tamper-proof secure board 40 is configured by including, as shown in FIG. 6, a board controller 401 including a CPU, a RAM 402, a ROM 403, a non-volatile memory 404 having tamper-proofness (for example, EEPROM), and an interface drive 405 and each of these components are connected with each other via a bus 406. In the ROM 403, a content data encryption processing program, an right certificate for delegate authentication issuance processing program, a license certificate issuance processing program, and a protection key issuance destination examination processing program are saved and in the non-volatile memory 404, a pubic key and a secret key of the license server 2 (a public key and a secret key are generated in pair by the license server 2) and the like are saved.

Then, when the tamper-proof secure board 40 is mounted on the board slot 35, the control part 31 of the license server 2 and the board controller 401 of the tamper-proof secure board 40 are enabled to perform data communication with each other via the interface drive 405 and the like and the control part 31 of the license server 2 reads out the above-mentioned various programs saved in the ROM 403 through the board controller 401 to execute them.

Note that detailed processing by the license server 2 will be explained later.

[4. Operation of Content Delivery System]

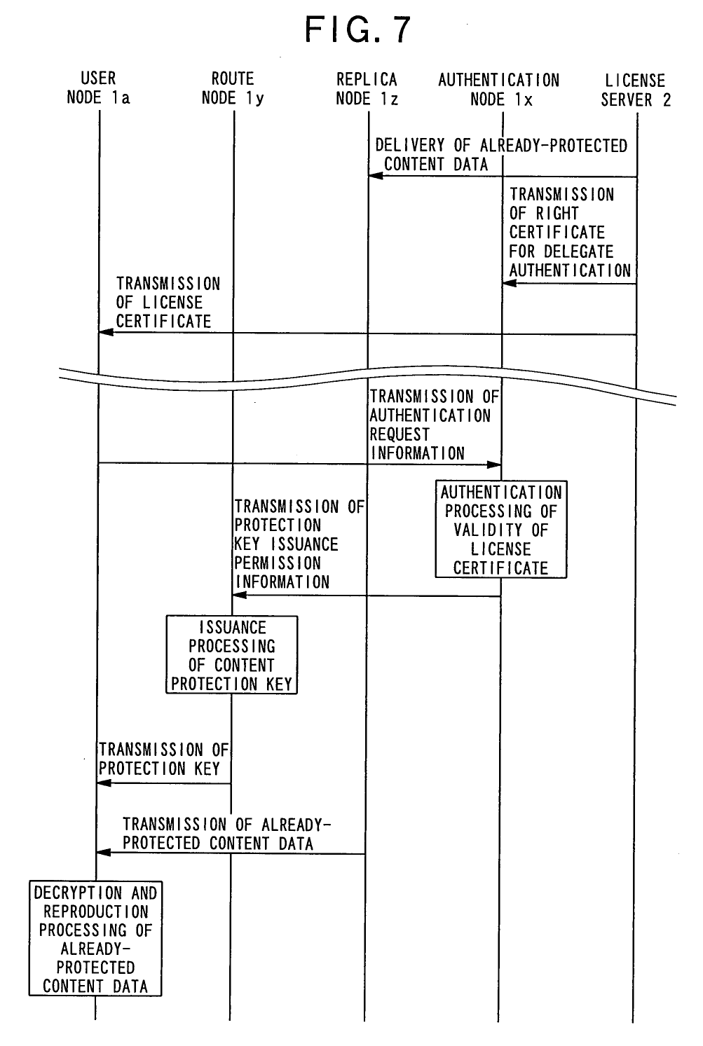

FIG. 7 shows an example of an overall flow in the content delivery system S.

Hereafter, according to the flow shown in FIG. 7, operation in the content delivery system S will be explained.

(4-1. Encryption and Storage of Content Data)

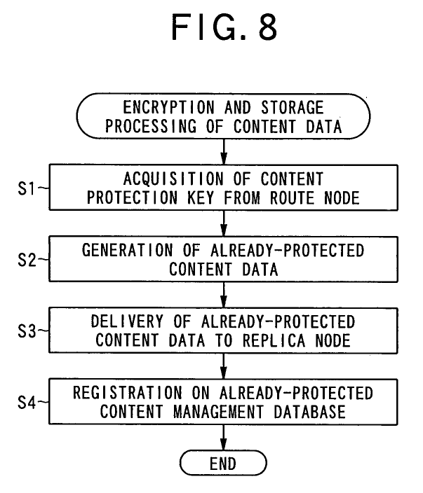

First, with reference to FIG. 8 and the like, operation in encryption and storage of content data will be explained.

FIG. 8 is a flow chart showing operations in encryption and storage processing of content data in the control part 31 of the license server 2. Note that in this explanation, it is assumed that the license server 2 has already obtained and stored content data to be stored in the replica node 1z.

The processing shown in FIG. 8 is performed when the control part 31 of the license server 2 executes the content data encryption processing program. In Step S1, the license server 2 selects content data to be stored in the replica node 1z (by, for example, encryption instruction from an operator via the input part 37) and acquires a content protection key to be used for the content data from the root node 1y of the content data.

For example, the license server 2 transmits information of acquiring protection key, to which content ID (hashed value of the content name), IP address of the license server 2 and the like have been attached, to the root node 1y according to the DHT routing. Then, the root node 1y generates a content protection key to be used for the content data or selects a content protection key which has already been generated and saved and transmits the key to the license server 2.

Subsequently, the control part 31 of the license server 2 generates already-protected content data using the content protection key thus received and acquired from the root node 1y and the accelerator for encryption 33 (Step S2).

Next, the control part 31 of the license server 2 delivers the already-protected content data to an arbitrarily selected replica node (Step S3) so that the data is stored.

Then, the control part 31 of the license server 2 makes a relation between the already-protected content data thus delivered and the replica node to which the already-protected content data has been stored, and registers the relation information to the already-protected content management database (Step S4) to finish the processing.

(4-2. Generation and Management of Content Protection Key)

Next, operation of the root node 1y when the content protection key is generated and managed will be explained.

Note that content protection key generation and management processing is performed when control part 11 of the root node 1y executes the protection key generation and management program.

The control part 11 of the root node 1y generates a content protection key at an arbitrary timing (for example, with a certain interval or when information of acquiring protection key is received). The content protection key thus generated is saved in the non-volatile memory 254 of the IC card 25 and, at the same time, protection key management information for managing the content protection key is registered in a content protection key management table saved in the non-volatile memory 254. Then, upon receiving information of acquiring protection key transmitted from the license server 2, the control part 11 of the root node 1y transmits the content protection key thus generated to the license server 2 according to the IP address of the license server 2.

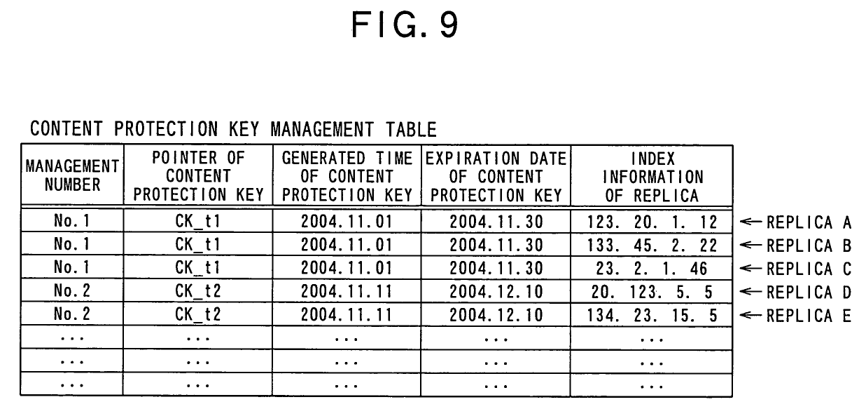

FIG. 9 shows an example of protection key management information registered in the content protection key management table.

In the content protection key management table shown in FIG. 9, management number (identification number) of the content protection key thus generated, pointer of the content protection key, generated time of the content protection key, expiration date of the content protection key, and index information of the replica are registered.

The pointer of the content protection key means a pointer indicating storage location where the content protection key is stored in the non-volatile memory 254 and when the control part 11 of the root node 1y refers to this, the control part 11 can recognize storage place of the content protection key.

Moreover, expiration date of the content protection key means a period during which already-protected content data can be decoded by the content protection key. Information indicating the expiration date is attached to the content protection key and when the expiration date expires, the content protection key loses the function thereof.

In addition, the index information of the replica is an IP address of a replica node in which location information of already-protected content data which has been encrypted by the content protection key, that is, the already-protected content data, is stored. The index information is transmitted to the root node 1y when already-protected content data is stored in a replica node (for example, by the license server 2 or the replica node). Note that the example of FIG. 9 shows that a plurality of one same content data are stored in five different replica nodes.

Furthermore, a content protection key of which expiration date has expired is deleted (erased) from the root node 1y and the user node 1a and the corresponding protection key management information is also deleted from the content protection key management table. In addition, the already-protected content data which has been encrypted by the content protection key thus deleted is deleted from a replica node and, at the same time, plain content data is encrypted again in the license server 2 by a content protection key newly generated by the root node 1y and stored in the replica node. That is, the content protection key and the already-protected content data are periodically updated and because of this, when, for example, content protection key is leaked out to a third party, damage can be lowered (reduced).

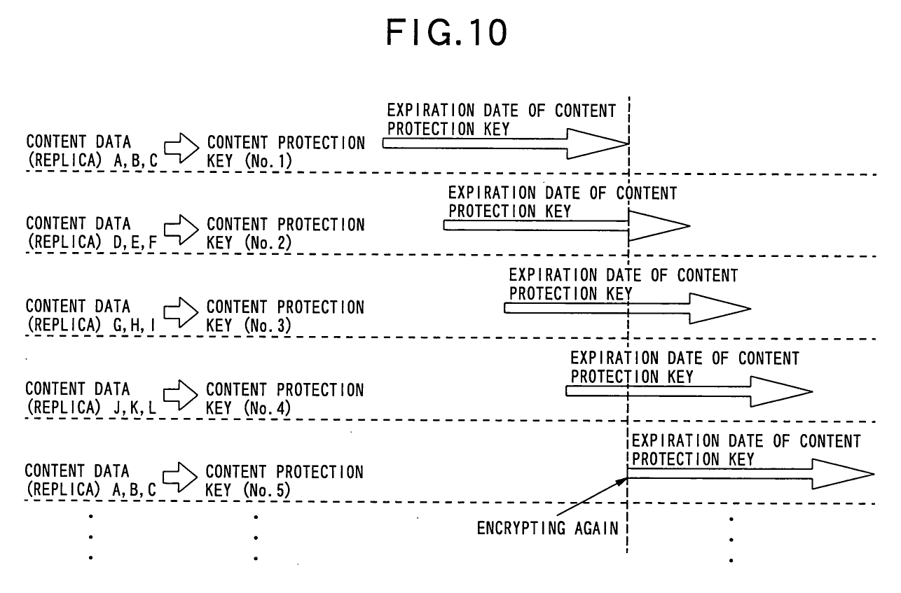

FIG. 10 shows an example of a case where a content protection key is updated.

In the example of FIG. 10, one same content protection key is allocated to a unit of three content data (for example, A, B, and C) among content data A to L which are replicas (that is, reproduced data). Moreover, in the example of FIG. 10, expiration date (validity period) of each content protection key is staggered (shifted) and when the expiration date passes, the content protection key is erased and content data is encrypted again to be stored. The reason why expiration dates of the content protection keys are staggered is to reduce load on the network. That is, when the expiration date of a content protection key passes, content data must be encrypted again using a newly generated content protection key. By shifting the expiration dates, the license server 2 does not have to encrypt many content data again and deliver the encrypted data to replica nodes again at a time.

Note that in the example shown in FIG. 10, three content data are allocated to one content protection key. However, in actual operation, consideration is given to the balance between number of types of content protection key retained by a root node and the total number of content data (that is, replica) so that the number of content data to be allocated to one content protection key becomes optimum.

(4-3. Issuance of THE RIGHT CERTIFICATE FOR DELEGATE AUTHENTICATION)

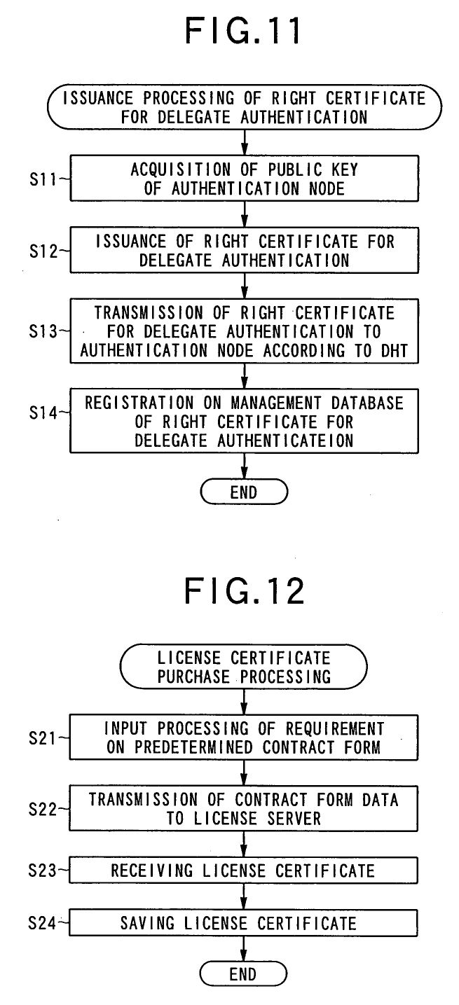

Next, with reference to FIG. 11 and the like, operation in issuance of THE RIGHT CERTIFICATE FOR DELEGATE AUTHENTICATION will be explained.

FIG. 11 is a flow chart showing issuance processing of THE RIGHT CERTIFICATE FOR DELEGATE AUTHENTICATION in the control part 31 of the license server 2.

The processing shown in FIG. 11 is performed when the right certificate for delegate authentication processing program is executed by the control part 31 of the license server 2 and in Step S11, the license server 2 acquires a public key of an authentication node 1x to which license authentication right for certain already-protected content data (for example, already-protected data newly stored in a replica node) is to be delegated.

For example, the license server 2 transmits authentication right request information (to which an authentication ID (content name of the content data and hashed value of suffix), IP address of the license server 2, and the like have been attached) to the authentication node 1x according to DHT routing (that is, the license server 2 transmits the authentication right request information to other node 1 and the authentication right request information thus transmitted passes through a relay node and reaches the authentication node 1x having a node ID which is closest to the authentication ID (for example, upper digits of the IDs match the most) according to DHT routing). Then, the authentication node 1x transmits a public key of the authentication node 1x itself to the license server 2 according to the IP address of the license server 2.

Subsequently, the control part 31 of the license server 2 generates THE RIGHT CERTIFICATE FOR DELEGATE AUTHENTICATION which includes the public key of the authentication node 1x thus received and acquired from the authentication node 1x, attach signature data thereto, and issues THE RIGHT CERTIFICATE FOR DELEGATE AUTHENTICATION (Step S12).

Next, the control part 31 of the license server 2 transmits an authentication ID and THE RIGHT CERTIFICATE FOR DELEGATE AUTHENTICATION thus issued to the authentication node 1x according to the DHT routing (Step S13). Thus, the authentication node 1x receives THE RIGHT CERTIFICATE FOR DELEGATE AUTHENTICATION and saves it in the non-volatile memory 254 of the IC card 25.

Then, the control part 31 of the license server 2 makes a relation between THE RIGHT CERTIFICATE FOR DELEGATE AUTHENTICATION thus issued and the information regarding an authentication node 1x, and registers the relation information in the management database of right certificate for delegate authentication (Step S14) and finishes the processing.

Note that transfer of license authentication right may be configured to have expiration date and in such a case, the license server 2 manages the expiration date of the license authentication right and when the expiration date passes, the license server 2 issues THE RIGHT CERTIFICATE FOR DELEGATE AUTHENTICATION again to transmit the certificate to the authentication node 1x. Moreover, in this case, in THE RIGHT CERTIFICATE FOR DELEGATE AUTHENTICATION, for example, expiration date of the license authentication right is included.

(4-4. License Certificate Issuance)

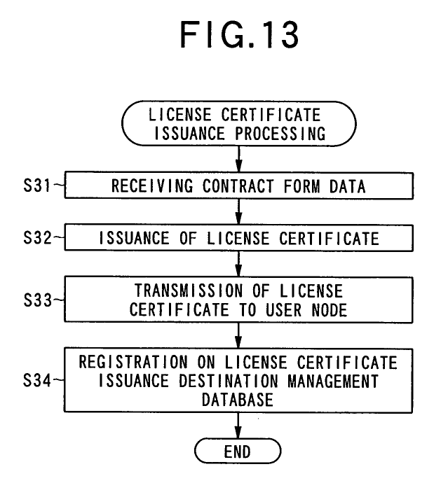

Next, with reference to FIGS. 12 and 13, operation in case of issuing license certificate will be explained.

FIG. 12 is a flow chart showing license certificate purchase processing in the control part 11 of a user node 1a and FIG. 13 is a flow chart showing license certificate issuance processing in the control part 31 of the license server 2.

The processing shown in FIG. 12 is performed when a license certificate purchase program is executed by the control part 11 of the user node 1a according to, for example, license certificate purchase instruction via the input part 22 by a user and in Step S21, input processing into requirement of a predetermined contract form is performed.

Subsequently, the control part 11 of the user node 1a transmits data of a contract form in which requirements have been inputted to the license server 2 according to the IP address of the license server 2 (Step S22).

In the license server 2, processing shown in FIG. 13 is performed when the license certificate issuance processing program is executed by the control part 31 and when the control part 31 receives data of the contract form thus transmitted from the user node 1a (Step S31), the control part 31 generates license certificate according to the contract form, attach signature data (that is, encrypted hashed value of the license certificate by a secret key of the license server 2), and issues the license certificate (Step S32).

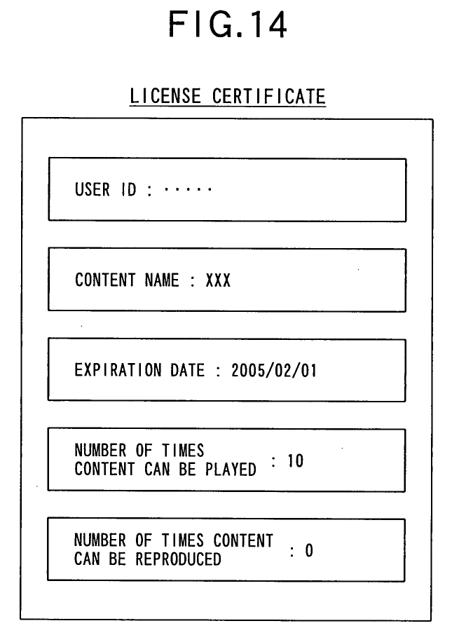

FIG. 14 is a conceptual diagram showing an example of content of license certificate.

In the example of FIG. 14, user ID, content name, expiration date, the number of times the content can be play backed, and the number of times the content can be copyed are described in the license certificate. The user ID is information for specifying a user and as long as a user can be specified, the information may be other information than user ID.

Then, the control part 31 of the license server 2 transmits the license certificate thus issued to the user node 1a according to the IP address of the user node 1a (Step S33).

Next, the control part 31 of the license server 2 makes a relation between the issued license certificate and the information regarding the user node to which the license certificate has been provided, and registers the relation information in license certificate destination management database (Step S34) and finishes the processing.

On the other hand, in FIG. 12, the control part 11 of the user node 1a receives license certificate thus transmitted from the license server 2 (Step S23), saves the certificate in the non-volatile memory 254 of the IC card 25 (Step S24) and finishes the processing.

(4-5. License Authentication and Issuance of Content Protection Key)

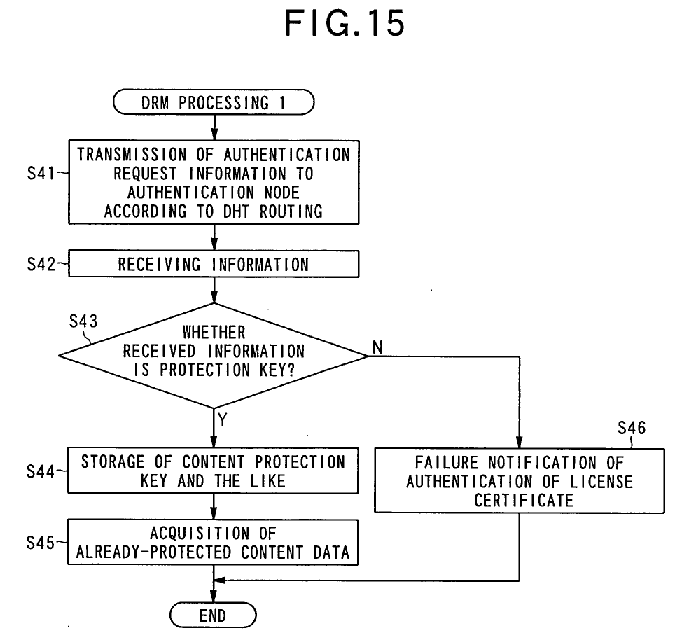

Next, with reference to FIGS. 15 to 17, operation in case of authentication of license certificate and issuance of a content protection key will be explained.

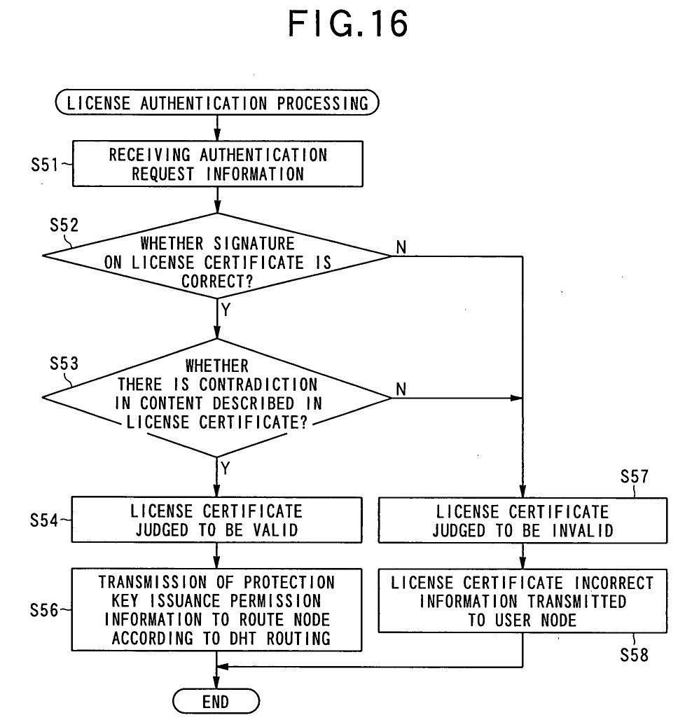

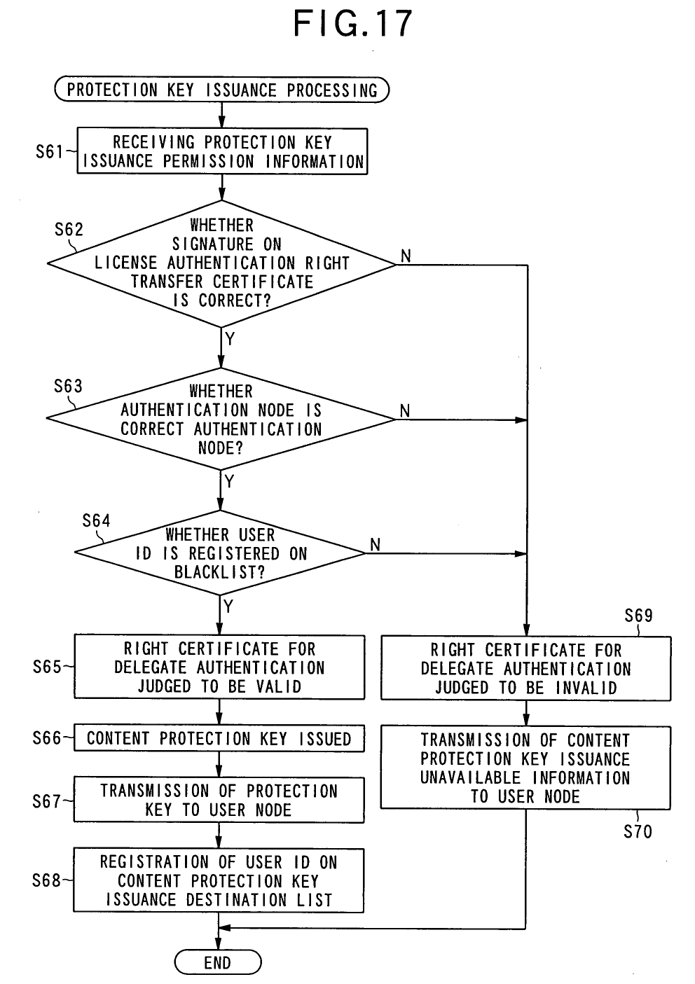

FIG. 15 is a flow chart showing DRM processing 1 (processing performed when a content protection key is requested) in the control part 11 of the user node 1a, FIG. 16 is a flow chart showing license authentication processing in the control part 11 of the authentication node 1x, and FIG. 17 is a flow chart showing protection key issuance processing in the control part 11 of the root node 1y.

The processing shown in FIG. 15 is performed when the DRM processing program is executed by the control part 11 of the user node 1a (a node which requests a content protection key) according to a content protection key acquisition (request) instruction from, for example, a user through the input part 22 and in Step S41, the control part 11 acquires license certificate (the license certificate saved in the Step S24) which certifies acquisition right of a content protection key corresponding to already-protected content data to be an acquisition target from the IC card 25 and, as acquisition right certificate transmission means, the control part 11 transmits authentication request information to which the license certificate, authentication ID, IP address of the user node 1a, and the like have been attached to the authentication node 1x according to DHT routing (that is, the license server 2 transmits the authentication request information to other node 1 and the authentication request information thus transmitted passes through a relay node according to the DHT routing and reaches the authentication node 1x having a node ID closest to the authentication ID (for example, a node ID of which upper digit numbers match the most)).

Then, in the authentication node 1x, processing shown in FIG. 16 is performed when the control part 11 executes a license authentication processing program and when the control part 11 receives authentication request information thus transmitted from the user node 1a as acquisition right certificate receiving means (Step S51), the control part 11 performs authentication processing of validity of the license certificate attached to the authentication request information as authentication means.

Specifically, the control part 11 of the authentication node 1x first judges whether signature on the license certificate is correct or not using a public key for the license server 2 (Step S52). That is, the control part 11 decrypts the hashed value (signature data) of the license certificate, which has been encrypted by a secret key of the license server 2, using the public key of the license server 2 to examine whether the hashed value of the license certificate matches the hashed value calculated by the authentication node 1x itself. Then, when the control part 11 judges that the signature on the license certificate is correct (that is, the hashed values match) (Step S52: Y), the control part 11 judges whether there is no contradiction in the description of the decrypted license certificate (Step S53). When there is no contradiction (for example, when user ID, content name, expiration date, the number of times content can be play backed, the number of times content can be copied are correctly described and the expiration date, these are in a range of a standard) (Step S53: Y), it is judged that the license certificate is valid (Step S54) and the processing proceeds to Step S56.

On the other hand, when it is judged in the Step S52 that the signature on the license certificate is incorrect (that is, the hashed values do not match) (Step S52: N) or in the Step S53 that there is contradiction in the description of the license certificate (Step S53: N), the control part 11 of the authentication node 1x judges that the license certificate is invalid (Step S57) and the processing proceeds to Step S58.

In Step S56, the control part 11 of the authentication node 1x generate a content ID by hashing a content name described in the license certificate and, further, transmits protection key issuance permission information (to which THE RIGHT CERTIFICATE FOR DELEGATE AUTHENTICATION, content ID, user ID, IP address of the user node 1a, and the like have been attached) to the root node 1y as issuance permission information transmission means according to DHT routing (that is, the authentication node 1x transmits the protection key issuance permission information to other node 1 and the protection key issuance permission information thus transmitted passes through a relay node according to the DHT routing and reaches the root node 1y having a node ID closest to the authentication ID (for example, a node ID of which upper digit numbers match the most)) to finish the processing.

Meanwhile, in Step S58, the control part 11 of the authentication node 1x transmits license certificate incorrect information (in which a fact that the license certificate is incorrect (invalid) is described) to the user node 1a according to the IP address of the user node 1a and finishes the processing.

Then, in the root node 1y, processing shown in FIG. 17 is performed when the control part 11 executes the protection key issuance processing program. When the control part 11 receives the protection key issuance permission information thus transmitted from the authentication node 1x as issuance permission information transmission means (Step S61), the control part 11 performs authentication processing to judge validity of THE RIGHT CERTIFICATE FOR DELEGATE AUTHENTICATION which has been attached to the protection key issuance permission information as authentication means.

Specifically, the control part 11 of the root node 1y first judges whether the signature on THE RIGHT CERTIFICATE FOR DELEGATE AUTHENTICATION is correct or not by use of a public key of the license server 2 (Step S62). That is, the control part 11 decrypts the encrypted hashed value (signature data) of THE RIGHT CERTIFICATE FOR DELEGATE AUTHENTICATION, which has been encrypted by a secret key of the license server 2, using the public key of the license server 2 to check whether the hashed value of THE RIGHT CERTIFICATE FOR DELEGATE AUTHENTICATION matches the hashed value calculated by the root node 1y itself.

Then, when the control part 11 judges that the signature on THE RIGHT CERTIFICATE FOR DELEGATE AUTHENTICATION is correct (that is, the hashed values match) (Step S62: Y), the control part 11 judges whether the authentication node 1x is a correct authentication node or not by use of the public key of the authentication node 1x included in thus decrypted THE RIGHT CERTIFICATE FOR DELEGATE AUTHENTICATION (Step S63).

For example, the control part 11 of the root node 1y generates a random number (an original random number) and transmits the random number to the authentication node 1x. The authentication node 1x receives the random number thus generated, encrypts the number by use of a secret key of the authentication node 1x itself, and replies the random number thus encrypted to the root node 1y. Then, the control part 11 of the root node 1y receives the random number thus encrypted and decrypts it by use of a public key of the authentication node 1x. When the original random number and the decrypted random number match together, it is judged that the authentication node 1x is a correct authentication node.

Note that when expiration date of the license authentication right is included in THE RIGHT CERTIFICATE FOR DELEGATE AUTHENTICATION, whether the expiration date has passed or not is also judged.

When it is judged that the node is a correct authentication node (Step S63: Y), the control part 11 of the root node 1y judges whether the user ID attached to the protection key issuance permission information is registered on a blacklist or not (Step S64). When the user ID is not registered on the blacklist (Step S64: N), it is judged that THE RIGHT CERTIFICATE FOR DELEGATE AUTHENTICATION is valid (Step S65) and the processing proceeds to Step S66.

On the other hand, when is it judged in the Step S62 that the signature on THE RIGHT CERTIFICATE FOR DELEGATE AUTHENTICATION is incorrect (that is, the hashed values do not match) (Step S62: N), in the Step S63 that it is not a correct authentication node (or expiration date of the license authentication right has expired) (Step S63: N), or the user ID is registered on the blacklist (Step S64: Y), the control part 11 of the root node 1y judges that THE RIGHT CERTIFICATE FOR DELEGATE AUTHENTICATION is invalid (Step S69) and the processing proceeds to Step S70.

In Step S66, the control part 11 of the root node 1y selects, for example, randomly, a content protection key managed in the content protection key management table and issues the key as playback-restriction releasing data issuance means.

Subsequently, the control part 11 of the root node 1y transmits protection key to which the content protection key thus issued and location information of already-protected content data encrypted by the content protection key (for example, IP address of a replica node) have been attached to the user node 1a according to IP address of the user node 1a as playback-restriction releasing data transmission means.

Then, the control part 11 of the root node 1y registers a user ID of the user node 1a to which the content protection key has been issued in the content protection key issuance destination list (Step S68) and finishes the processing.

On the other hand, in Step S70, the control part 11 of the root node 1y transmits content protection key issuance unavailable information in which reasons such as THE RIGHT CERTIFICATE FOR DELEGATE AUTHENTICATION is invalid (or the authentication node 1x has no authentication right) are described to the user node 1a according to the IP address of the user node 1a and finishes the processing.

Then, as shown in FIG. 15, the control part 11 of the user node 1a receives information thus transmitted from the authentication node 1x or the root node 1y (when the information is protection key, receives as playback-restriction releasing data receiving means) (Step S42), and judges whether the information is protection key or not, that is, whether a content protection key has been issued or not (Step S43). When the information thus received is protection key (Step S43: Y), the control part 11 of the user node 1a saves the content protection key and location information of the already-protected content data to the non-volatile memory 254 of the IC card 25 (Step S44). Then, the control part 11 of the user node 1a transmits request information for already-protected content data to the replica node according to the location information of the already-protected content data, receives already-protected content data transmitted from the replica node in response to the request as delivery information acquisition means (that is, downloads and acquires) (Step S45), and saves the information in the storage part 12 to finish the processing.

Note that when IP addresses of a plurality of replica nodes are described in the location information of already-protected content data thus acquired from the root node 1y (that is, a plurality of content data (replicas) have been encrypted by the acquired (purchased) content protection key to be stored in a plurality of replica nodes), the control part 11 of the user node 1a, for example, may randomly select an IP address of one replica node or cause a user to select an IP address of any of the replica nodes to acquire already-protected content data from the replica node thus selected.

Meanwhile, when the information thus received is not the protection key (Step S43: N), that is, the information thus received is license certificate incorrect information transmitted from the authentication node 1x or content protection key issuance unavailable information transmitted from the root node 1y, information indicating that authentication of the license certificate failed or acquisition of the content protection key failed is, for example, displayed on the display part 17 or outputted as voice from the speaker 19 to notify the user (Step S46) and the processing is finished.

Note that in operations in authentication of the license certificate and issuance of the content protection key, authentication request information is transmitted from the user node 1a to the authentication node 1x according to the DHT routing. However, the present invention is not limited thereto and, for example, the user node 1a may transmit the authentication request information to the root node 1y according to the DHT routing of which key is a content ID and the root node 1y may transmit the authentication request information thus received to the authentication node 1x according to DHT routing of which key is authentication ID (that is, content name of the content data+hashed value of suffix) (following processing is the same as above embodiment).

Moreover, in the operation of authentication of the license certificate and issuance of the content protection key, the root node 1y transmits the protection key. However, the present invention is not limited thereto and, for example, the root node 1y may transmit the protection key to a replica node based on the location information of already-protected content data and the replica node may transmit the content protection key included in the protection key to the user node 1a together with already-protected content data.

(4-6. Decryption and Playback of Already-Protected Content Data)

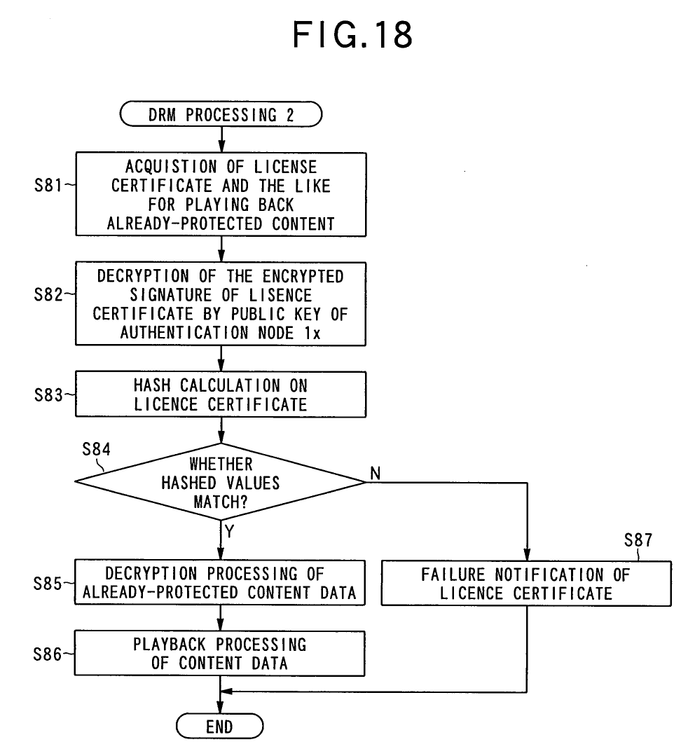

Next, with reference to FIG. 18 and the like, operations in decryption and playback of already-protected content data will be explained.

FIG. 18 is a flow chart showing DRM processing 2 (processing performed when a content protection key is used) in the control part 11 of the user node 1a.

The processing shown in FIG. 18 is performed when a DRM processing program is executed by the control part 11 of the user node 1a according to playback instruction (for example, pressing of a playback button by a user) of already-protected content data by a user via the input part 22. In Step S81, the control part 11 acquires license certificate of already-protected content data to be played back from the IC card 25.

Then, the control part 11 of the user node 1a decrypts the encrypted signature data of the license certificate thus acquired using a public key of the license server 2 (Step S82).

Subsequently, the control part 11 of the user node 1a calculates hashed value of the license certificate based on the license certificate thus acquired (Step S83) and judges whether there is identity between the hashed value of the license certificate thus calculated and hashed value of the license certificate acquired by decryption (whether the contents are identical or not) (Step S84). Thus, by judging identity of hashed valued of license certificates, the user node 1a can verify that a content protection key has been issued through a correct authentication route.

Then, when it is judged that there is identity between the hashed values of both of the license certificates (Step S84: Y), the control part 11 acquires a content protection key corresponding to the license certificate from the IC card 25 to decrypt the already-protected content data which is to be played back (that is, to release playback-restriction) (Step S85), causes the decoder part 15, image processing part 16, and audio processing part 18 to play back decrypted content data (that is, to output image and audio regarding the content data) (Step S86), and finishes the processing.

Following the above, the control part 11 of the user node 1a refers to the number of times the data can be played back and number of times the data can be copied which are described in the license certificate and plays back or copies the decrypted content data. For example, in the user node 1a, the number of times the content data is played back (or copied) is counted up (incremented) each time the content data is played back (or copied) and saved in the storage part 12 to be managed and, at the same time, when the content data is played back (or copied), the managed number of times the content data has been played back (or copied) and the number of times the content data can be played back (or copied) are compared and when the number of times the content data has been played back (or copied) is smaller than the number of times the content data can be played back (or copied), the content data can be played back (or copied).

Moreover, the control part 11 of the user node 1a erases (deletes) a license certificate and a content protection key corresponding to the license certificate when the expiration date described in the license certificate has passed and causes the license server 2 to issue a license certificate again to acquire (purchase) it. Then, the control part 11 of the user node 1a transmits authentication request information to which the reissued license certificate and the like have been attached to the authentication node 1x according to DHT routing and acquires location information of a content protection key reissued by the root node 1y and already-protected content data (similar to the processing in FIGS. 15 to 17). Thus, damage when a content protection key is leaked to a third party can be reduced.

On the other hand, when it is judged that there is no identity between the hashed values of the license certificates (Step S84: N), the control part 11 of the user node 1a, for example, causes the display part 17 to display information that the license certificate is not correct, or causes the speaker 19 to output the information as voice to notify a user (Step S87) and the processing is finished without decrypting or playing already-protected content data.

(4-7. Examination on Destination of Illegally Issued Content Protection Key)

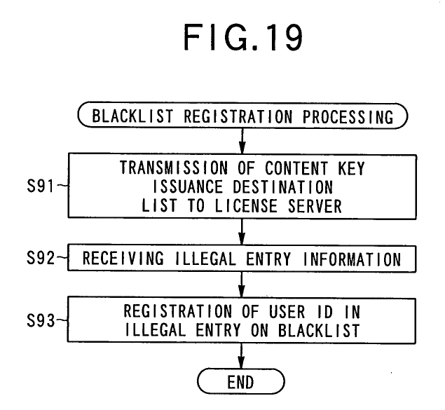

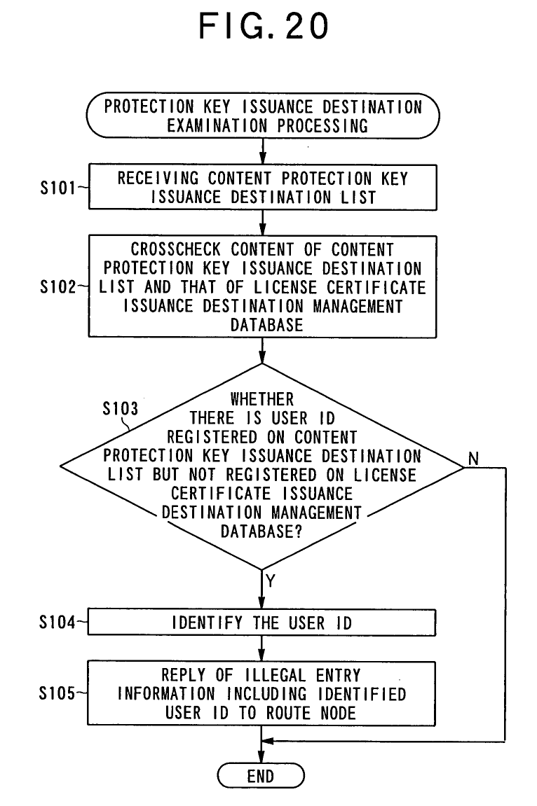

Next, with reference to FIGS. 19, 20, and the like, operation in case of examining destination of illegally issued content protection key will be explained.

FIG. 19 is a flow chart showing blacklist registration processing in the control part 11 of the root node 1y and FIG. 20 is a flow chart showing protection key issuance destination check processing in the control part 31 of the license server 2.

The processing shown in FIG. 19 is performed when blacklist registration processing is executed by the control part 11 of the root node 1y, for example, at a predetermined frequency (for example, in one day periods).

The control part 11 of the root node 1y first acquires a content protection key issuance destination list from the IC card 25 and transmits the list to the license server 2 according to the IP address of the license server 2 (Step S91).

Then, in the license server 2, the processing shown in FIG. 20 is performed when the control part 31 executes a protection key issuance destination examination processing program. When the control part 31 receives the content key issuance destination list thus transmitted from the root node 1y (Step S101), content of the content protection key issuance destination list and content of the license certificate issuance destination database are crosschecked (Step 102), it is judged whether there is any user ID registered on the content protection key issuance destination list but is not registered on the license certificate issuance destination management database though the content protection key corresponds to the license certificate (Step S103), and when there is (Step S103: Y), the user ID is identified (Step S104). That is, a user ID of a user to whom a content protection key has been issued though license certificate has not been issued is identified.

Next, the control part 31 of the license server 2 replies (reports) illegal entry information including the user ID thus identified to the root node 1y (Step S105) and finishes the processing.

Then, the control part 11 of the root node 1y receives the illegal entry information thus transmitted from the license server 2 (Step S92), registers the user ID included in the illegal entry information as a user ID of a user who violates copyrights law on the blacklist (Step S93), and finishes the processing.

Thus, when a user node having a user ID registered on the blacklist transmits, for example, authentication request information to request issuance of a content protection key again when a content protection key expires (processing shown in FIG. 15), the root node 1y can appropriately reject issuing the content protection key.

Note that in the processing in Step S103, when a content protection key has been issued though a license certificate has not been issued, the license server 2 may judge that an illegal collusion occurred in an authentication route including a user node, an authentication node, and a root node and for the next transfer processing of license authentication right (for example, when the license authentication right has expiration date), the license server 2 does not transfer license authentication right to the authentication node in the above authentication route (for example, do not reissue THE RIGHT CERTIFICATE FOR DELEGATE AUTHENTICATION).

As explained above, according to the above embodiment, authentication processing regarding issuance permission of a content protection key is distributed to a plurality of nodes 1 and performed for each content data having the same content name. Therefore, it is possible to prevent a specific device, such as a server, which performs authentication processing conventionally, from being charged with too much processing load. Moreover, issuance processing of a content protection key is also performed for each content data having the same content name. Therefore, it is possible to prevent a specific device, from being charged with too much processing load. Furthermore, since content protection keys are managed by different nodes for different content, even if the content protection key is leaked out, damage caused by that can be reduced and safety, reliability, and the like regarding copyright protection can be ensured.

In addition, according to the embodiment above, since different nodes independently perform authentication processing regarding issuance permission of a content protection key and issuance processing of the content protection key, it is possible to prevent illegal collusion and to raise safety, reliability, and the like regarding copyright protection. Moreover, it is also possible to issue a safe content protection key while maintaining load distribution, which is an advantage in P2P.

Furthermore, in the embodiment above, since an authentication node to which authentication right has been transferred by the license server 2 performs authentication processing and a user node transmits authentication request information to the authentication node by DHT routing instead of direct transmission, it is difficult for the authentication node and the user node to illegally collude and therefore, reliability of the authentication node can be raised. In addition, when THE RIGHT CERTIFICATE FOR DELEGATE AUTHENTICATION has an expiration date, reliability of the authentication node can be raised further.

Still furthermore, in the embodiment above, since the license certificate has expiration date, damage when a content protection key is leaked to a third party can be reduced.

### Embodiment 1

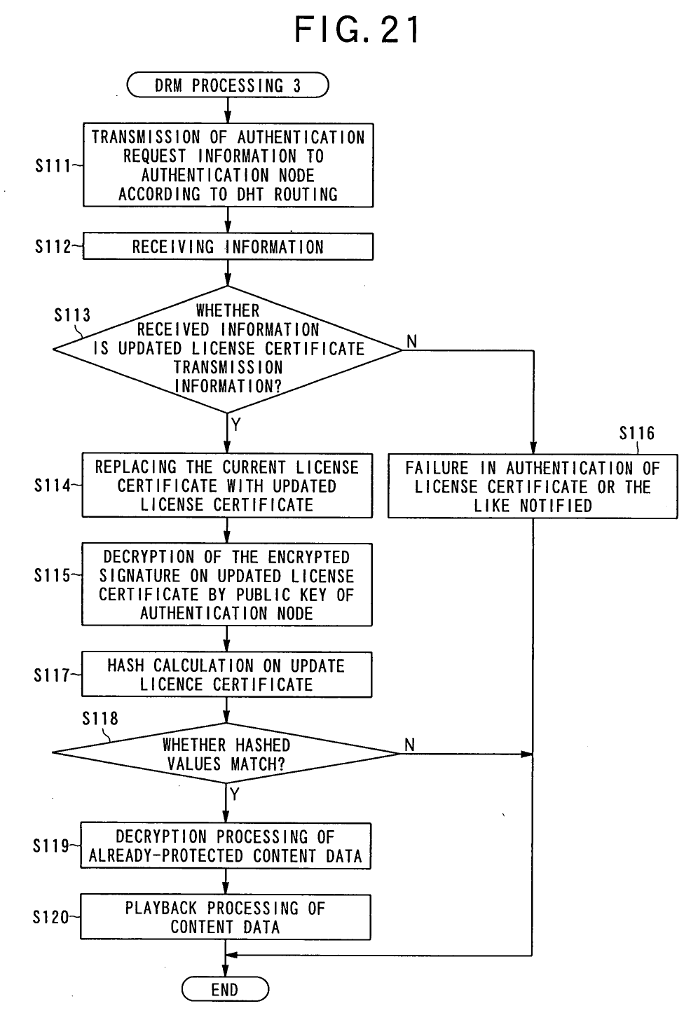

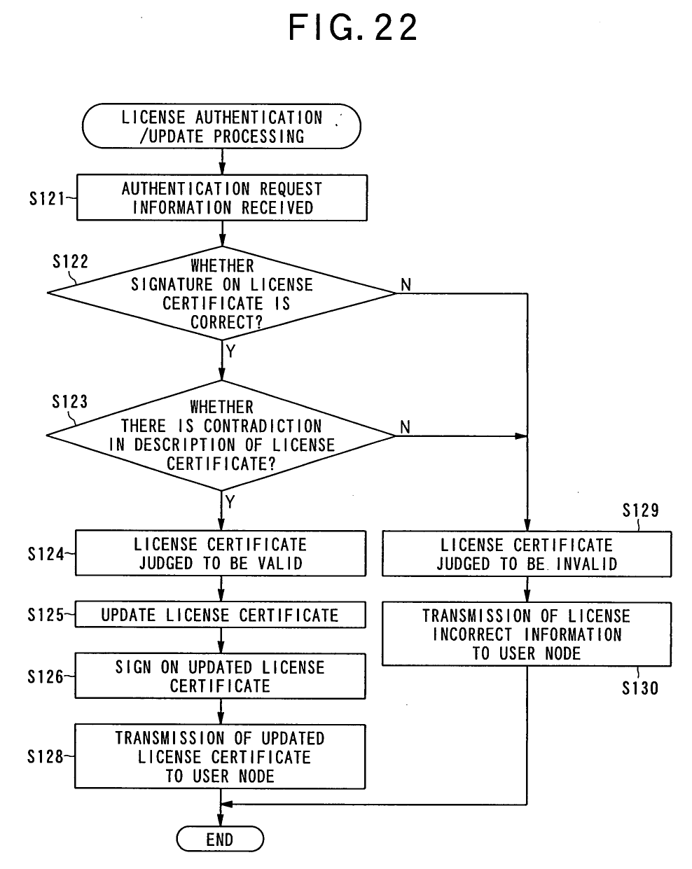

In the above embodiment, a configuration in which number of times the content can be played back described in a license certificate is not updated was explained. As other example, operation in a case where number of times the content can be played back described in a license certificate is updated by the authentication node 1x will be explained with reference to FIGS. 21, 22, and the like.

FIG. 21 is a flow chart showing DRM processing 3 in a case where license certificate is updated in the control part 11 of the user node 1a and FIG. 22 is a flow chart showing license authentication and update processing in the control part 11 of the authentication node 1x.

Note that the following explanation is made on a premise that the user node 1a has acquired a license certificate, a content protection key, and already-protected content data.

The processing shown in FIG. 21 is performed when the DRM processing program is executed by the control part 11 of the user node 1a according to, for example, playback instruction of already-protected content data from a user via the input part 22. In Step S111, the control part 11 acquires a license certificate of already-protected content data to be played back from the IC card 25 and transmits authentication request information to which the license certificate, authentication ID, IP address of the user node 1a, and the like have been attached to the authentication node 1x according to DHT routing.

Then, in the authentication node 1x, the control part 11 executes the license authentication and update processing program to perform processing shown in FIG. 22. When the control part 11 receives authentication request information thus transmitted from the user node 1a (Step S121), the control part 11 performs authentication processing of validity of the license certificate thus attached to the authentication request information.

Specifically, the control part 11 of the authentication node 1x first judges whether the signature on the license certificate is correct or not by use of a public key of the license server 2, similarly to the above-mentioned Step S52 (Step S122). When the signature on the license certificate is correct (Step S122: Y), the control part 11 judges whether there is contradiction in the description of the license certificate (decrypted license certificate) (Step S123) and when it is judged that there is no contradiction (similarly to the above-mentioned Step S53) (Step S123: Y), validity of the license certificate is authenticated (Step S124) and the processing proceeds to Step S125.

On the other hand, when the signature on the license certificate is not correct in the above-mentioned Step S122 (Step S122: N), or when there is contradiction in the description of the license certificate in the above-mentioned Step S123 (Step S123: N), the control part 11 of the authentication node 1x recognizes that the license certificate is invalid (Step S129) and the processing proceeds to Step S130.

In Step S125, the control part 11 of the authentication node 1x reduces the number of times the content can be played back, which is described in the license certificate, by one (1 decrement) to update the license certificate.

Subsequently, the control part 11 of the authentication node 1x signs on the license certificate thus updated (that is, hashed value of the license certificate after update is encrypted with a secret key of the authentication node 1x. The license certificate before update (original) is authorized by the signature by the license server 2, but the license certificate after update is authorized by the signature by the authentication node 1x) (Step S126).

Then, the control part 11 of the authentication node 1x transmits (replies) updated license certificate information to which the license certificate after update (signed) and THE RIGHT CERTIFICATE FOR DELEGATE AUTHENTICATION have been attached to the user node 1a (Step S128) and finishes the processing.

Meanwhile, in Step S130, the control part 11 of the authentication node 1x transmits license certificate incorrect information in which a fact that the license certificate is incorrect (invalid) is described to the user node 1a and finishes the processing.

Then, as shown in FIG. 21, the control part 11 of the user node 1a receives information transmitted from the authentication node 1a (Step S112) and judges whether the information is updated license certificate transmission information or not (Step S113). When the information thus received is the updated license certificate transmission information (Step S113: Y), the control part 11 of the user node 1a replaces the license certificate attached to the updated license certificate transmission information with the license certificate before update which is saved in the non-volatile memory 254 in the IC card 25 (Step S114) and the processing proceeds to Step S115.

On the other hand, when the information thus received is not the updated license certificate transmission information (Step S113: N), information indicating that acquisition of license certificate failed is displayed on the display part 17 or outputted as voice by the speaker 19 to notify the user (Step S116) and the processing is finished.

In Step S115, the control part 11 decrypts signature data of the license certificate after update thus acquired by a public key of the authentication node 1x.

Subsequently, the control part 11 of the user node 1a calculates hashed value of the license certificate after update thus acquired (Step S117), compares the hashed value of the license certificate after update thus calculated and the hashed value of the license certificate after update thus acquired and decrypted, and judges whether there is identity between them (Step S118).

Then, when it is judged that there is identity between the hashed values of both of the license certificates thus updated (Step S118: Y), the control part 11 acquires a content protection key corresponding to the license certificate from the IC card 25, decrypts the already-protected content data which is to be played back using the content protection key and the decryption accelerator 14 (Step S119), causes the decoder part 15, image processing part 16, and audio processing part 18 to play back decrypted content data (Step S120), and finishes the processing. Note that when there is no identity between both of the updated license certificates (Step S118: N), the processing is finished without performing decryption and playback of the already-protected content data. Note that the user node 1a can confirm the authenticity of the license certificate after update by THE RIGHT CERTIFICATE FOR DELEGATE AUTHENTICATION acquired from the authentication node 1x.

According to such a configuration, whenever there is already-protected content data playback instruction (for example, pressing of a playback button by a user), inquiry from the user node 1a to the authentication node 1x (license authentication and update request) occurs. However, it is possible to manage the number of times already-protected content data can be played back more strictly and to prevent illegal act by a user more surely. Note that such a configuration is more effective to a node device such as a set top box (STB) which is always connected to the internet.

### Embodiment 2

In the above embodiments, authentication processing corresponding to content data having certain content name is performed by one authentication node. However, as other example, redundancy regarding authentication processing may be raised by transferring license authentication right to a node located in the vicinity of a route on a spanning tree in DHT routing. Note that “a node located in the vicinity of a route on a spanning tree” includes a relay node on a route through which authentication request information is transferred from a user node to an authentication node and a node in the vicinity of the relay node. For example, in case of DHT routing such as Pastry, since each node manages vicinity node information other than DHT as Leaf Set, in the vicinity of a route on a spanning tree (a spot around which routing converges), both a node on the relay route and a node in the vicinity thereof may include authentication function (same is applied to the following key issuance function).

Moreover, in this case, the authentication node sends out (transmits) a broadcast message which is periodically time to live (TTL) controlled to authentication nodes other than the self to notify the existence of the self and recognizes total amount of authentication nodes by receiving broadcast messages sent out from authentication nodes other than the self. When the total amount is lower than a predetermined amount, an authentication node which detected this phenomenon first may request the license server 2 to appoint a general node in the vicinity (for example, a node having a small hop number) to be an authentication node. According to such a configuration, licensing function in the system S can be stabilized.

### Embodiment 3

In the above embodiments, content protection key issuance processing corresponding to content data having a certain content name is performed by one content protection key issuance node (for example, a root node). However, as other example, a node located in the vicinity of a route on a spanning tree in DHT routing may have issuance right of a content protection key to raise redundancy regarding the content protection key issuance processing.

Further, in this case, a content protection key issuance node transmits (sends out) a broadcast message which is periodically time to live (TTL) controlled to content protection key issuance nodes other than the self to notify the existence of the self and recognizes total amount of content protection key issuance nodes by receiving broadcast messages sent out from content protection key issuance nodes other than the self. When the total amount is lower than a predetermined amount, a content protection key issuance node which detected this phenomenon first may request the license server 2 to appoint a general node in the vicinity (for example, a node having a small hop number) to be a content protection key issuance node. According to such a configuration, licensing function in the system S can be stabilized.

### Embodiment 4

In the above embodiments, a case where one node executes function of both a root node and a content protection key issuance node has been taken as an example for explanation. However, the present invention is not limited thereto and the function of a root node and the function of a content protection key issuance node may be performed by two nodes independently. In this case, for example, the authentication node 1x transmits protection key issuance permission information, to which THE RIGHT CERTIFICATE FOR DELEGATE AUTHENTICATION, a user ID, IP address of the user node 1a, and the like have been attached, to the content protection key issuance node according to DHT routing (in this case, content ID+hashed value of a suffix different from the above-mentioned suffix is a key) and the content protection key issuance node transmits issued content protection key information to which issued content protection key and THE RIGHT CERTIFICATE FOR DELEGATE AUTHENTICATION have been attached to the user node 1a. Then, the user node 1a transmits information requesting location information of already-protected content data to a root node according to DHT routing, which is a content ID for the user node 1a, to acquire the location information from the root node.

Furthermore, when the function of an authentication node, a root node, and content protection key issuance are performed by different nodes, a user node first transmits information requesting location information of already-protected content data (including a license certificate) to a root node according to DHT routing, which is a content ID for the user node 1a. Then, the root node transmits authentication request information for the license certificate to the authentication node. Result of authentication is transmitted to the root node and when the result shows correct authentication, the root node may request issuance of a content protection key to a content protection key issuance node, receive a content protection key from the content protection key issuance node, and transmit location information of already-protected content data and the content protection key to the user node. Moreover, the root node may transmit authentication request information of a license certificate and location information of already-protected content data to the authentication node and the authentication node may transmit authentication result to a content protection key issuance node corresponding to the location information of already-protected content data thus received so that location information of already-protected content data is transmitted from the root node to the user node and the content protection key is transmitted from the content protection key issuance node to the user node.

Note that in the present embodiment, a node which performs authentication processing regarding issuance permission of the content protection key and a node which performs issuance processing of the content key independently to prevent illegal collusion and raise safety, reliability and the like regarding copyrights protection. Therefore, this embodiment is preferable from a viewpoint of operation. However, as long as the safety can be raised by a certain method, the authentication processing regarding issuance permission of a content protection key and issuance processing of a content protection key may be performed by one node (for example, above-mentioned authentication node, content protection key issuance node (root node), or the like).

In addition, in the above embodiment, a certain user node is not prevented from functioning as an authentication node or a content protection key issuance node corresponding to already-protected content data to be requested by another user node.

Furthermore, in the above embodiment, the overlay network 9 configured by algorithm utilizing DHT is a premise for explanation. However, the present invention is not limited thereto and is applicable to other computer network systems.

Note that the present invention is not restricted to the above embodiments. The embodiments are examples and any device or system that has substantially same configuration to the technical idea described in the claims of the present invention and exhibits similar effects is included in the technical scope of the present invention.

What is claimed is:

1. An information delivery system having a plurality of node devices communicable each other via a network and a plurality of delivery information with their playback-restricted, the delivery information being distributed to the plurality of node devices and saved therein,
wherein authentication processing regarding issuance of playback-restriction releasing data for releasing the playback-restriction on the delivery information is distributed into the plurality of node devices, and
the plurality of node devices carry out the authentication processing thus distributed.

2. The information delivery system according to claim 1,
wherein the authentication processing corresponding to each of the delivery information is performed by a node device corresponding to each of the delivery information.

3. The information delivery system according to claim 1,
wherein a first node device which requests the playback-restriction releasing data corresponding to one delivery information has acquisition right certificate data for certifying acquisition right of the playback-restriction releasing data and includes an acquisition right certificate transmission means for transmitting the acquisition right certificate data; and
a second node device which performs the authentication processing corresponding to the one delivery information comprising:
an acquisition right certificate receiving means for receiving the acquisition right certificate data;
an authentication means for authenticating validity of the acquisition right certificate data thus received;
a playback-restriction releasing data issuing means for issuing the playback-restriction releasing data corresponding to the one delivery information when it is authenticated that the certificate is valid by the authentication means; and
a playback-restriction releasing data transmission means for transmitting the playback-restriction releasing data thus issued.

4. The information delivery system according to claim 1,
wherein the first node device which requests the playback-restriction releasing data corresponding to one delivery information has acquisition right certificate data for certifying acquisition right of the playback-restriction releasing data and includes acquisition right certificate transmission means for transmitting the acquisition right certificate data, and
the second node device which performs the authentication processing corresponding to the one delivery information includes:
an acquisition right certificate receiving means for receiving the acquisition right certificate data;
an authentication means for authenticating validity of the acquisition right certificate data thus received; and
an issuance permission information transmission means for transmitting issuance permission information indicating issuance permission of the playback-restriction releasing data corresponding to the one delivery information when validity is authenticated by the authentication means,
wherein a third node device includes:
an issuance permission receiving means for receiving the issuance permission information;
a playback-restriction releasing data issuing means for issuing playback-restriction releasing data indicated by the issuance permission information thus received; and
a playback-restriction releasing data transmission means for transmitting playback-restriction releasing data thus issued.

5. The information delivery system according to claim 4,
wherein the second node device has authentication right certificate data which certifies the authentication right and the issuance permission information transmission means transmits the issuance permission information and the authentication right certificate data, and
the issuance permission information receiving means of the third node device receives the issuance permission information and the authentication right certificate data, and the third node device further includes an authentication means for authenticating validity of authentication right certificate data thus received; and the playback-restriction releasing data issuing means issues the playback-restriction releasing data only when validity is authenticated by the authentication means.

6. The information delivery system according to claim 4,
wherein the playback-restriction releasing data issuing means of the third node device transmits location information indicating location of the playback-restriction releasing data and the one delivery information corresponding to the playback-restriction releasing data.

7. The information delivery system according to claim 3,
wherein the first node device further includes:
a playback-restriction releasing data receiving means for receiving the playback-restriction releasing data; and
a playback means for playing back the delivery information after releasing playback-restriction of the one delivery information by the playback-restriction releasing data thus received.

8. The information delivery system according to claim 6,
wherein the first node device further includes:
a playback-restriction releasing data receiving means for receiving the playback-restriction releasing data and the location information;
a delivery information acquisition means for acquiring the one delivery information on the basis of the location information thus received, and;
a playback means for playing back the delivery information after releasing playback-restriction of the one delivery information thus acquired by the received playback-restriction releasing data.

9. The information delivery system according to claim 3,
wherein a node device is caused to function as the first node device.

10. The program which causes a computer to function as the node device according to claim 9.

11. A node device which functions as the second node device included in the information delivery system according to claim 3.

12. A program which causes a computer to function as the node device according to claim 11.

13. A node device which functions as the third node device included in information delivery system according to claim 4.

14. A program which causes a computer to function as the node device according to claim 13.

15. A playback-restriction releasing data issuing in an information delivery system where a plurality of delivery information with its playback restricted are distributed and stored into a plurality of node devices, included in the information delivery system and mutually communicable through a network, and where authentication processing regarding issuance of playback-restriction releasing data for releasing restriction in reproducing each of the delivery information is distributed to the plurality of node devices and carried out therein, wherein
a first node device which requests the playback-restriction releasing data corresponding to one of the delivery information includes acquisition right certificate data, certifying acquisition right of the playback-restriction releasing data, and transmits the acquisition right certificate data, and
a second node device which performs the authentication processing corresponding to the one delivery information receives the acquisition right certificate data, authenticates validity of the acquisition right certificate data, issues the playback-restriction releasing data corresponding to the one delivery information when the validity is authenticated, and transmits the playback-restriction releasing data.

16. A playback-restriction releasing data issuing method in an information delivery system where a plurality of delivery information with its playback restricted are distributed and stored into a plurality of node devices, included in the information delivery system and mutually communicable through a network, and where authentication processing regarding issuance of playback-restriction releasing data for releasing restriction in reproducing each of the delivery information is distributed to the plurality of node devices and carried out therein, wherein
a first node device which requests the playback-restriction releasing data corresponding to one of the delivery information includes acquisition right certificate data, certifying acquisition right of the playback-restriction releasing data, and transmits the acquisition right certificate data, and
a second node device which performs the authentication processing corresponding to the one delivery information receives the acquisition right certificate data, authenticates validity of the acquisition right certificate data, and when the validity is authenticated transmits issuance permission information which indicates issuance permission of the playback-restriction releasing data corresponding to the one distribution information, and
a third node device receives the issuance permission information, issues playback-restriction releasing data indicated in the issuance permission information, and transmits the playback-restriction releasing data.
